(19) United States
(12) Patent Application Publication
(10) Pub. No.: US 2018/0163571 A1
(43) Pub. Date: Jun. 14, 2018

(54) OXYFUEL POWER PLANT PROCESS

(71) Applicants: Sebastian Obermeier, Munich (DE); Alexander Alekseev, Wolfratshausen (DE)

(72) Inventors: Sebastian Obermeier, Munich (DE); Alexander Alekseev, Wolfratshausen (DE)

(21) Appl. No.: 15/833,227

(22) Filed: Dec. 6, 2017

Related U.S. Application Data
(60) Provisional application No. 62/431,881, filed on Dec. 9, 2016.

(51) Int. Cl. F01K 11/02; F01K 9/02; F01K 9/00; F01K 7/16

(52) U.S. Cl. CPC F01K 11/02; F01K 9/02; F27D 2009/0013; F01K 7/16; F23J 2219/70; F01K 9/003

(57) ABSTRACT

An oxyfuel power plant having improved efficiency of operation by the provision of at least two condensation units, the first being a warmer operating direct contact cooler and the second being a colder operating direct contact cooler. Each apparatus is loaded with a different quantity of water, with the warmer direct contact cooler having two to three times the amount of water that is in the colder direct contact cooler.

### CROSS REFERENCE TO RELATED APPLICATIONS

This application claims priority from U.S. Provisional Application 62/431,881 filed on Dec. 9, 2016.

### BACKGROUND OF THE INVENTION

The invention relates to a method for operation of an oxyfuel power plant, wherein conversion of energy is accomplished by burning a hydrocarbon-containing energy source in a combustion space using an oxygen-enriched atmosphere and the generated heat is transmitted to a steam power plant circuit.

The invention also relates to an apparatus for conversion of energy having a combustion space for combustion of a hydrocarbon-containing energy source using an oxygen-enriched atmosphere and a steam power plant circuit that is energy-coupled to the combustion space and configured to use the heat generated in the combustion space.

Traditional pressureless oxyfuel power plants burn hydrocarbon-containing fuels (liquid, gaseous or solid) in oxygen-rich conditions. It is also known to burn the hydrocarbon-containing fuels in an oxygen-enriched atmosphere, or in pure oxygen so that the flue gas contains primarily CO₂ and water vapor. Following cool down of the flue gas to ambient temperature, the water vapor is normally condensed out leaving a gas phase that is substantially made up of CO₂ that can be separated using a simple separator. The CO₂ is generally forced into the ground or intercalated (carbon capture and storage) to avoid contamination of the Earth's atmosphere (otherwise a contributor to global warming). The water condensation proceeds at low temperatures, e.g. less than 110° C. and therefore the energy content of the needed heat is very low. For this reason, there is usually no attempt made to recover lost heat for use elsewhere in the plant. Because the heat from the condensation energy is discarded, the process efficiency is degraded.

Another known oxyfuel power plant process employs a boiler where the fuel and oxygen are compressed to high pressure of above 5 bar and as much as 50 bar and combustion takes place at high pressures. The flue gas and CO₂ remaining, after the H₂O is condensed out, that exits the outlet of the boiler remains at a high pressure. The high pressure operation is advantageous as the entire flue gas path can be more compact because of the reduced volume of the high pressure gas. An important advantage of this type of operation is that the flue gas dew point, i.e. the temperature at which condensation of the flue gas begins, at the high pressure is significantly higher than the dew point from a conventional oxyfuel process. This results in the condensation heat being at significantly higher temperatures and therefore the energy content from condensed heat is also much more valuable. Recapture and Integration of this heat into the power plant process is therefore desirable and increases the overall efficiency of the plant. For example, the recaptured energy can be used for preheating a working fluid, such as feed water, of a steam power plant circuit, and results in an increase of total efficiency of the system (e.g. power plant).

One method of reusing the condensation heat is to carry out the flue gas condensation process in a conventional heat exchanger. In this process the water vapor condensed from the flue gas is condensed in the heat exchanger and flows in a counter flow to the boiler feed water (BFW) of the steam power plant and acts to preheat the BFW.

FIG. 1 is a schematic diagram showing a prior art steam cycle without integration of condensing heat. As shown in FIG. 1, steam can be removed from the main stream cycle and provided BFW preheaters prior to use by steam turbines, (HP, MP or LP turbines). However, this considerable reduces the main steam stream and therefore also results in a reduction of power generated by the turbine(s). By preheating the BFW by means of the flue gas condensation heat, it is possible to reduce the quantity (flow of the steam extractions) of steam removed from the main cycle and thereby increase the total power of the steam cycle. In addition, the amount of tapped steam from the turbines that may be needed for pre-heating of the BFW can be significantly reduced. This in turn allows the turbines to generate more electrical power or mechanical power.

However, one challenge for this type of operation is that the flue gas (and correspondingly flue gas condensate) generally contains not pure water molecules, but also a number of soluble flue gas contaminates, such as Sox (sulfur oxides), NOx (nitrogen oxides), etc. These substances are soluble in water creating strong acids. In addition, because of the high pressures prevailing in the system, the solubility of carbon dioxide in water also rises. These factors result in very high requirements on the flue gas condensation heat exchanger. The high pressures, high temperatures, a relatively large heat quantity to be transferred, along with strong acidic solution (high pH-value) on the flue gas condensate side, create requirements for the system to use expensive high quality corrosion-resistive materials and very high technical efforts. These requirements can be met only by a system and equipment that require high installation and operation cost.

Another disadvantage of the operation using condensation heat described above is that the available condensation heat of the flue gas is greater than the heat required for pre-heating the BFW. Therefore, the total amount of condensation heat available can therefore not be completely integrated into the method and used, resulting is loss of potential improvement and efficiency.

An improvement to the above described method and apparatus is described in US Published Patent Application 2014/0007576, incorporated by reference herein. In this solution the flue gas, formed in the combustion of the hydrocarbon-containing energy source, is cooled in a direct-contact cooler wherein the flue gas directly contacts a water-containing coolant. The apparatus for this improvement includes the combustion space for combustion of the hydrocarbon-containing energy source in an oxygen-enriched atmosphere and a steam power plant circuit. The steam power plant is energy-coupled to the combustion space in order to use the heat generated in the combustion space. Further a direct-contact cooler is connected downstream from the combustion space for cooling the flue gas from the combustion space by direct contact with a water-containing coolant.

As shown in the drawing figures of US Published Patent Application 2014/0007576, an intermediate water cycle between the boiler feed water preheating part of the process and flue gas condensing part and a direct contact cooler instead of the conventional heat exchanger are used. The flue gas is guided into the direct contact cooler from below and water is injected into the direct contact cooler from the top. The heat and material exchange between the rising flue gas and the downward flowing water, resulting in the flue gas being cooled down and the water being heated. The acidic contaminates are partially “washed out”, i.e. are dissolved in the water, and become diluted thereby considerably reducing the pH-value and as well as reducing the risk of corrosion.

However, the heat exchange from this system still exhibits inefficiency and has relatively high thermodynamic losses. For example, FIG. 2 is a graph which illustrates the heat removed from the flue gas in the form of warm water for a power plant of approximately 500 MW. The energy losses are in the range of 15-20 MW, which represents 3-4% of the power plant output.

There remains a need in the art for improvements to flue gas condensation to increase efficiency and reduce heat loss.

### SUMMARY OF THE INVENTION

The invention relates provides apparatus and methods to improve the efficiency of operation of an oxyfuel power plant. This is accomplished according to the invention by providing at least two condensation apparatus, one apparatus being a warmer direct contact cooler and the other being a colder direct contact cooler. Each apparatus is loaded with a different quantity of water, with the warmer direct contact cooler having two to three times the amount of water that is in the colder direct contact cooler.

### BRIEF DESCRIPTION OF THE DRAWINGS

FIG. 1 is a schematic diagram showing a prior art steam cycle without integration of condensing heat.

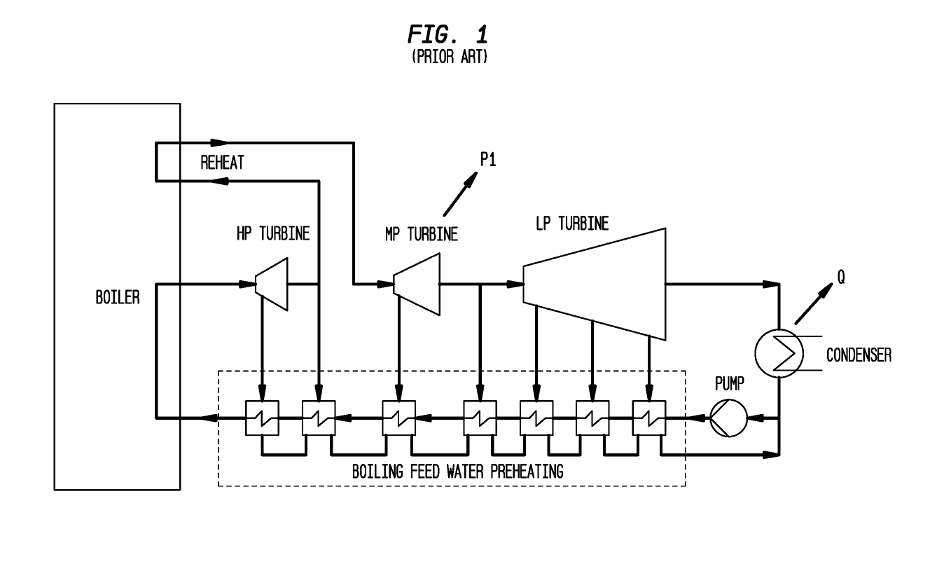

FIG. 2 is a graph illustrating the heat removed from the flue gas in the form of warm water for a power plant of approximately 500 MW.

FIG. 3 is a schematic diagram of an oxyfuel power plant according to one embodiment of the invention.

FIG. 4 is a schematic diagram of an oxyfuel power plant according to another embodiment of the invention.

### DETAILED DESCRIPTION OF THE INVENTION

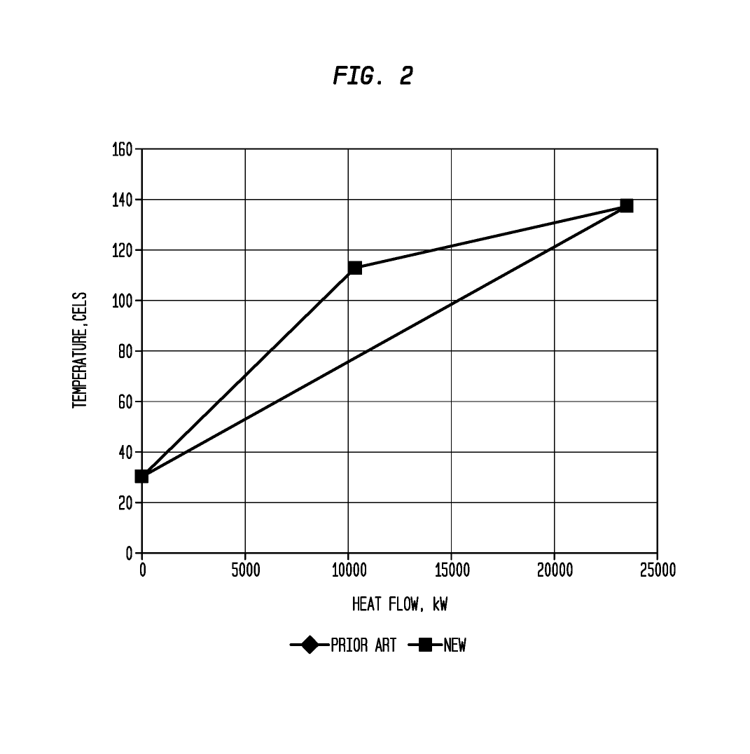

The invention will be described in greater detail with reference to FIGS. 2, 3 and 4.

The apparatus and method according to the invention makes better use the condensation heat as shown in FIG. 2. The graph of FIG. 2 shows that the apparatus and method according to the invention has about half of the energy loss compared to the apparatus and process of the prior art. This increases total efficiency of the power plant by about 1-2%.

These improvements are accomplished by an apparatus and methods that includes at least two condensation apparatus. A first direct contact cooler F operates at a relatively warmer temperature and a second direct contact cooler G operates at a relatively colder temperature. Each direct contact cooler is loaded with a different quantity of water, with the warmer direct contact cooler F having two to three times the amount of water that is in the colder direct contact cooler G.

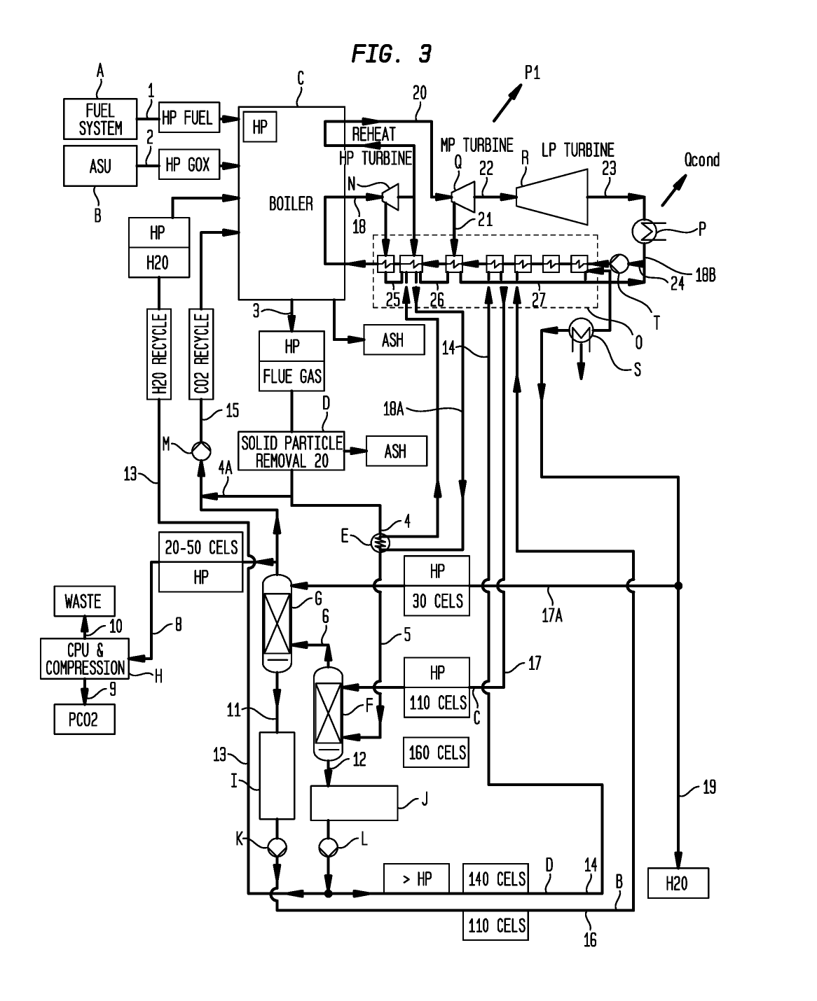

As shown in FIG. 3, the system of the invention comprises an oxyfuel power plant having a boiler (combustion space) C for burning a hydrocarbon-containing energy source 1 in an oxygen-enriched atmosphere 2. The oxyfuel power plant includes a fuel system A for supplying fuel and an air-separation unit (ASU) B to provide the oxygen-rich atmosphere. Heat from the combustion is provided to a steam power plant circuit O to produce mechanical energy in a variety of turbine systems N, Q and R, connected by lines 18, 21 to the power plant circuit designated O.

The oxygen flow produced in the ASU is provided at a pressure above the combustion space pressure, for example, at 80 bar or more. The temperature at the outlet of the ASU is roughly ambient temperature, i.e. 20° C.

Flue gas formed by combustion leaves 3 the boiler C and is treated in a solid particle removal apparatus D to remove solid particles and removed from the system as ash. The flue gas 4 is then to the direct-contact cooler system F and G according to the invention. Alternatively, the fluid gas may be directed through line 4A into line 15 for feeding into a compressor M before being fed through line 15 into boiler C. As shown in FIG. 3, the direct-contact cooler system F and G of the invention comprises two separate direct-contact cooler tanks or columns, each of which may contain fillings or structured packing.

According to the invention the flue gas is fed 5 into a lower region of the first direct-contact cooler F and rises in counterflow to coolant that is trickling down through the first direct-contact cooler F. After passing through the first direct-contact cooler F, the flue gas is fed 6 into a lower region of the second direct-contact cooler G and again rises in counterflow to coolant that is trickling down through the second direct-contact cooler. In accordance with the invention the first direct-contact cooler operates at a higher temperature than the second direct-contact cooler.

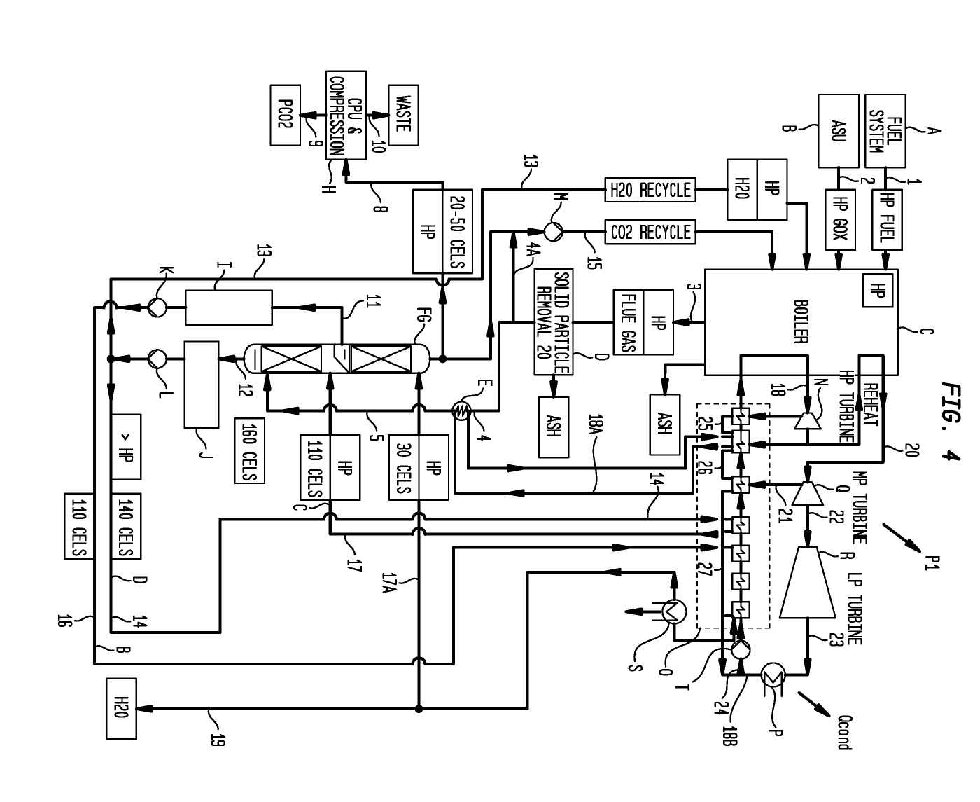

As described, FIG. 3 shows an embodiment of the invention wherein the first and second direct-contact coolers are separate units. Another embodiment of the invention is shown in FIG. 4, wherein the second direct-contact cooler is stacked on top of the first direct-contact cooler to form a single unit, such that F and G in FIG. 3 are replaced with the single direct-contact cooler assembly FG, which has no connection line 6 as in FIG. 3, otherwise all other number elements are the same in FIG. 4 as in FIG. 3. In this embodiment, the flue gas is fed to a lower region of the first direct-contact cooler and rises through both the first and second direct-contact coolers against counterflow of coolant, fed independently to the region near the top of each of the first and second direct-contact coolers.

The direct-contact coolers F and G cool and partially liquefy the flue gas. Further, because of the direct contact with the coolant flow (water flow), most of the water vapor condenses 11 and 12 out of the flue gas. The cooled flue gas leaving the second direct-contact cooler may be sent 8 and 13 to a CPU and compression unit H for separation into liquid CO₂ product 9 and a residual waste gas 10, or otherwise directed through compressor M and line 15 into boiler unit C. Other treatment steps can be performed also, such as further cleaning of the CO₂ flow.

The coolant, primarily water, 11 and 12 can be withdrawn from the bottom of the direct-contact coolers F and G. The temperature of the water corresponds to the dew point of the flue gas at a given pressure and a given flue gas composition. The water is chemically conditioned in I and J and then cooled so that it can be recirculated 11 and 12 and provided again as coolant 14 and 17 to the direct-contact coolers F and G. The circulation of the water flow can be carried out using pumps K and L and can be divided into separate uses within the plant. For example, a portion of the water can be used for feed-water preheating 14 of the steam power plant circuit O, while another portion of the water 13 can be used to preheat the oxygen flow 2 from the ASU B. Water from pump K may be fed through line 16 to the steam power plant circuit O where the hot water may contribute heat to the hot water present in the boiler units therein.

The steam power plant circuit O is a standard known circuit using a working fluid that can be vaporized for conversion of heat into mechanical work (energy). The working fluid 18 is expanded in a steam turbine (Rankine process) N, Q and R coupled to a generator for generating a flow. The working fluid is brought to a high pressure by means of a pump T and then vaporized by supplying heat and superheated. It is then expanded to a low pressure in the steam turbine N, Q and R. After condensation in a condenser P, the fluid 18 is again brought to high pressure. The working fluid 18, after passing through the high pressure turbine N is split at line 20 either being fed into the steam power plant circuit O or fed through boiler C to gain heat for feeding into the medium pressure turbine Q which will deliver working fluid through line 21 to the steam power plant circuit O. The medium pressure turbine Q will feed working fluid through line 22 to the low pressure turbine R which feeds the working fluid through line 23 to the condenser P.

Working fluid may be withdrawn from the steam power plant circuit O through line 18A and passed to heat exchanger E which can provide some heat to the flue gas which is fed through line 5 into the direct contact cooler F. The working fluid continues through heat exchanger E where it is returned through line 18A back to the steam power plant circuit O.

The working fluid 18A which is withdrawn from condenser P is fed through line 24 to pump T where it is returned into the steam power plant circuit O. Lines 25, 26 and 27 connect the various boiler units (not labelled) in the steam power plant circuit O. These various boiler units can be any number that provides the necessary hot water for use in the cycle. Line 27 will direct water from the various boilers and feed it into condenser P or through pump T for re-entry back into the steam power plant circuit O.

Water may also be extracted from the steam power plant O through line 19 where it is optionally passed through a water cooler S where it may be discharged in an environmentally conscious manner. Alternatively, the water may be withdrawn from line 19 into line 17A where it may be fed into direct contact cooler G where it can provide water for trickle down within the direct contact cooler G.

As noted the flue gas flow is fed into a lower region of the direct-contact coolers and flows upward in counterflow to the coolant that is fed into an upper region of the direct-contact coolers F and G and trickles down through the direct-contact coolers F and G. To boost intensive contact of the gas with the liquid, the direct-contact coolers F and G may contain filling or packing. Because of the high temperatures and pressures, the use of ceramic or metal filling or packing is preferred (e.g., random packing such as Raschig rings, Pall rings, and Berl saddles, and structured packing such as Koch-Sulzer packing, Intalox packing, or Mellapak, or combinations of random and structured packing).

The hydrogen containing energy source A (fuel, propellant) can be a solid, liquid or gaseous feedstock. To produce the condensation heat at a temperature level to be efficiently used, the pressure of the combustion space for the hydrocarbon-containing energy source is above atmospheric pressure. This results in the flue gas also having an elevated pressure and a corresponding dew point (dew point temperature).

The pressure range for the combustion is from 5 to 100 bar (abs.), preferably 40 to 100 bar (abs.). Depending on the specific flue gas composition, the dew point of the flue gas at a flue gas pressure of 80 bar, is above 200° C. The oxygen-enriched atmosphere as used in the invention is an atmosphere that contains a larger oxygen portion than ambient air, for example, at least 80% oxygen, and preferably about 97% oxygen.

To protect the apparatus and lines of the water circuit against corrosion, the water withdrawn through 11 and 12 from the direct-contact coolers can be treated and conditioned in units I and J to achieve a predetermined pH value or by the addition of anti-corrosion agents.

The invention provides many advantages over the prior art. One advantage of the invention is that transport of heat and mass in a direct-contact apparatus is much more intense than in a heat exchanger and therefore the heat transfer or heat exchange proceeds more efficiently. This requires less surface area and results in a considerable cost reduction. Another advantage of the invention is that the flue makes direct contact with the coolant and therefore flue gas washing takes place. In this manner at least some of the water vapor of the flue gas is condensed and washed out of the flue gas. Therefore, the cooled flue gas leaving the direct-contact coolers contains a smaller portion of water than the hot flue gas flow that entered.

The invention also provides the advantage that the condensation heat of the flue gas is not provided directly to the feed water of the steam power plant circuit, but rather to the coolant flow that is then used as a heat transfer medium. The usable heat of the flue gas is therefore released to a heat transfer medium that can then relay or distribute the heat to one or more operations and therefore enables efficient and flexible use of the condensation heat.

It is anticipated that other embodiments and variations of the invention will become readily apparent to the skilled artisan in the light of the foregoing description, and it is intended that such embodiments and variations likewise be included within the scope of the invention as set out in the appended claims.

1. An oxyfuel power plant system comprising:
at least two condensation units for condensing water out of a flue gas emitted from a boiler of the oxyfuel power plant system,
wherein the at least two condensation units are direct contact coolers and
wherein a first direct contact cooler is operated at a warmer temperature in comparison to a second direct contact cooler.

2. (canceled)

3. The system as claimed in claim 1, wherein the direct contact coolers are loaded with a different quantity of coolant.

4. The system as claimed in claim 3, wherein the first direct contact cooler is loaded with two to three times the amount of coolant compared to the second direct contact cooler.

5. The system as claimed in claim 4, wherein the direct contact coolers contain fillings or structured packings.

6. The system as claimed in claim 5, wherein the fillings or structured packings are made of ceramic or metal.

7. The system as claimed in claim 6, wherein the second direct contact cooler is stacked on top of the first direct contact cooler.

8. A method of operating an oxyfuel power plant system comprising condensing water from a flue gas emitted from a boiler of the oxyfuel power plant system in at least two condensation units,
wherein the at least two condensation units are direct contact coolers and
wherein a first direct contact cooler is operated at a warmer temperature in comparison to a second direct contact cooler.

9. The method as claimed in claim 8, wherein the direct contact coolers are loaded with a different quantity of coolant.

10. The method as claimed in claim 9, wherein the first direct contact cooler is loaded with two to three times the amount of coolant compared to the second direct contact cooler.

11. The method as claimed in claim 10, wherein the coolant is water.

12. The method as claimed in claim 9, wherein the flue gas is fed into a lower region of the first direct contact cooler and rises in counterflow to the coolant that is trickling down in the first direct contact cooler and the flue gas is next further fed into a lower region of the second direct contact cooler, where the flue gas rises in counterflow to the coolant that is trickling down in the second direct contact cooler.

13. The method as claimed in claim 11, wherein the coolant of the first direct contact cooler and/or the coolant of the second direct cooler is used as a heat transfer medium to recover condensation heat of the water present in the flue gas.

14. The method as claimed in claim 8, wherein the at least two condensation units are operated at higher than 50 bar.

15. The method as claimed in claim 14, wherein the at least two condensation units are operated at 5 to 50 bar.
